(19) United States
(12) Patent Application Publication
(10) Pub. No.: US 2003/0003258 A1
(43) Pub. Date: Jan. 2, 2003

(54) Method for joining panels using pre-applied adhesive

(75) Inventors: Scott R. Durso, Moncure, NC (US); Stephen E. Howe, New Hill, NC (US); Mark W. Pressley, Apex, NC (US)

Correspondence Address: Lord Corporation, 111 Lord Drive, PO Box 8012, Cary, NC, 27512-8012, US

(73) Assignee: Lord Corporation

(21) Appl. No.: 10/142,340

(22) Filed: May 9, 2002

Related U.S. Application Data
(60) Provisional application No. 60/290,424, filed on May 11, 2001.

(51) Int. Cl. B32B 3/00; B32B 7/12; B32B 15/04; B32B 33/00

(52) U.S. Cl. 428/53; 428/55; 428/41.8

(57) ABSTRACT

The invention is directed to assembly of a plurality of joined panel parts. Some of the individual parts contain a pre-applied curable adhesive to one or more sides or edges. An initiating metal activator is applied to complementing edges and cure is activated when the parts are assembled. The pre-applied adhesive system contains monomer(s), initiators, oligomers, an acid, and a sulfonyl compound. An activating or initiating metal foil, dispersion or coating is applied to the complementary surface. The bonding is effected when the adhesive system is activated by mating the edges. The activating metal is a reducible elemental transition metal. The metal is affixed to one surface which is brought into proximity with the curable adhesive compound dispensed onto the complementing part. The invention has usefulness in the joining of wood, wood products, composites of wood, thermoset polymer panels, non-initiating metal panels, and thermoplastic/wood composites, and the like to provide self-bonding assemblies having appearance surfaces, such as wall or floor coverings, especially assemblies that used joined board-like construction members.

This application claims benefit of U.S. Provisional Application No. 60/290,424, filed May 11, 2001.

### FIELD OF THE INVENTION

The invention related to the field of adhesive bonding of non-metallic panels, such as low, medium or high density fiberboard, laminates thereof, and/or thermoplastic substrates.

### BACKGROUND OF THE INVENTION

Pre-assembled articles, for example home furnishings, office components, can be configured to utilize engineered mechanical fastening systems which are recessed and include covering systems to improve the finished aesthetic appearance. Many furniture articles, and office panel systems contain such state of the art fastening mechanisms. Pre-applied adhesive systems for these articles are not established due to activation and/or cure activation mechanisms that would be cumbersome or inconsistently applied by installers, and therefore unacceptable to obtain the structural integrity needed with on-site assembly of pre-fabricated components. Nevertheless, an adhesive system which is pre-applied at the fabrication stage would be industrially desirable, especially for home furnishings and office components that provide a continuous decorative surface of joined panels or slats. These are assembled at the site and may be anchored to structural supports such as a floor or wall. It would be of industrial importance to provide a pre-applied adhesive system that does not require additional activation steps, and would activate, bond and cure to high strength simply on assembly.

Designing a pre-applied adhesive system with read-to-assemble bonding characteristics presents several challenges to achieve shelf-stability, green-strength, open time, curing time, and ultimate bond strength to hold the panel or slat members together upon installation. The adhesive must also possess controllable properties within sufficient application tolerances from the standpoint of the fabrication process. The inventors have undergone extensive development adaptation of an adhesive system that can be pre-applied to non-initiating metal substrates, such as steel panels or slats and later bonded after assembly.

U.S. Pat. No. 3,658,254 is directed to two-package anaerobic acrylic adhesive. This system is not readily adaptable as a pre-applied adhesive system.

U.S. Pat. Nos. 3,880,956 and 3,957,561, disclose anaerobic acrylic adhesive compositions which are activated by contact with metal surfaces. The compositions are single-package anaerobic compositions containing diazonium salt catalysts which cure through a free radical polymerization mechanism when excluded from air or oxygen and in contact with certain metal surfaces.

U.S. Pat. No. 3,957,561 discloses one-package anaerobic compositions utilizing a two-component catalyst system comprising at least one diazosulfone compound and o-sulfobenzimide which cure through a free radical polymerization mechanism when the adhesive is excluded from air or oxygen and in contact with active metal surfaces.

U.S. Pat. No. 4,052,244, utilizes copper in the form of a copper salt of saccharin or p-toluenesulfonic acid to provide two-package anaerobic adhesives whose cure is otherwise not dependent on substrate composition.

U.S. Pat. No. 4,081,308, discloses two-package adhesives which utilize, in one package, copper saccharinate or saccharin in combination with a soluble copper salt, and in the other package, an alpha-hydroxy sulfone, an alpha-aminosulfone or mixtures of such sulfones, as catalytic agents for the free radical curing of the anaerobic acrylic adhesive compositions. The cure of the Skoultchi U.S. Pat. No. 4,081,308 compositions is independent of substrate composition.

U.S. Pat. Nos. 4,703,089; 4,855,001; and 4,857,131 disclose one-package acrylic adhesives which cure at ambient temperatures when brought into contact with certain metal surfaces, whether or not air or oxygen is excluded. The adhesive contains an olefinically unsaturated monomer, a polymeric material, a sulfonyl halide, a transition metal, and an acidic compound. Sulfonyl halide-containing adhesives may, in some instances, catalyze or promote corrosion which may lead to the degradation of the adhesive bond.

### SUMMARY OF THE INVENTION

The invention is directed to apparatus and method for joining the apparatus, which comprises panels or slats which are pretreated on one or more than one bonding edge(s), up to all bonding edges provided on one set of panels, with an adhesive that is cured by an initiator or activating metal containing layer applied to one, or more, or all edges of a complementing set of panels, the complementing set to be joined in a plurality of bonded panels by curing and bonding at the edge surfaces. The adhesive is advantageously applied at the fabrication stage of the panels. An inert metal activator is applied, i.e., affixed to the complementary edge on the same or other panel. The fabricated, adhesive-treated panels or slats can be stored unassembled for extended periods of time prior to assembly. Storage stability under environmental conditions commonly encountered in the industry is achieved. At the time of installation, such as at a work site, the prefabricated panels materials are unpacked and the edges containing the adhesive are mated to the complementary edges containing the inert metal activator layer. The adhesive is activated, and provides a designed open time as little or as long so to provide for any adjustment of the assembly if needed, and the assembly is bonded together by the curing after further time to provide a structurally sound bond that can withstand flexure, or tension over long periods of time without disengagement of the members.

In the method aspect, two parts are joined by assembling opposing complimentary edges together, one set of complementing edges contains adhered to its surfaces a resin compound comprising, in admixture,

(a) at least one olefincially unsaturated monomer,

(b) an organic or inorganic acid,

(c) a sulfonyl compound,

(d) an optional oligomer; and

(e) a thixotrope;

And affixed to the opposite complementing edges is a transition metal activator which is placed in contact with the adhesive resin, and curing is initiated, forming a bond between the complimentary edges.

The adhesive viscosity is in advantageously provided in the range of about 20,000 to 40,000 Cps using conventional thickeners and/or fillers. One such thickener is a conventional thixotrope.

To the opposite bonding side(s) a layer containing a foil or dispersed particulate transitional metal initiator, affixed for example by an adhesive coated, for instance on the metallic foil, or tape. The transitional metal initiator can be present as a metal-doped binder coating on at least a portion of the bonding surface on the sides opposing or complimentary to the bonding surfaces containing the pre-applied curable resin compound.

In the case of the substrates being manufactured wood products, such as wood panels or slats, an edge sealant is preferably first applied prior to applying the adhesive and the initiating metal layer. The sealant provides a moisture barrier and a barrier to inhibit the migration of residues that interfere with curing of the adhesive. A UV curable edge sealant applied to unfinished edges of wood-products unexpectedly provided significantly reduced moisture gain.

### BRIEF DESCRIPTION OF DRAWINGS

FIG. 1 depicts in crossection, a tongue and groove joint showing adhesive resin applied to the grooves on slat 10a, and initiator affixed to the tongue on slat 10b.

FIG. 2 depicts in crossection two slats providing a lap-joining feature.

FIG. 3 depicts in crossection two slats providing a scarf-joining feature.

FIG. 4 depicts in crossection two slats providing a spleen-joining feature.

FIG. 5 depicts in crossection two slats providing a finger-joining feature.

FIG. 6 depicts in crossection two slats aligned prior to joining in a snap-fit engagement.

### DETAILED DESCRIPTION OF THE PREFERRED EMBODIMENTS

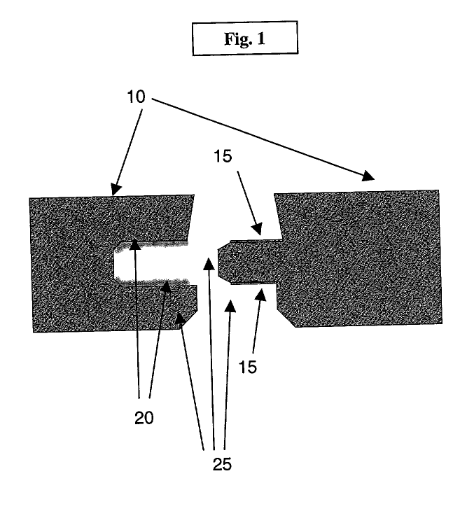

With reference to the figures wherein like references depict like features and elements, FIG. 1 depicts two parts to be joined by a tongue and groove joint. There is an appearance surface at 10, an adhered initiator or activator metal-layer at 25a, made up, for example, by a particulate metal containing coating or binder containing metal particles, an adhered foil, a particulate metal-doped ink, or a metal-containing tape at 15. The pre-applied adhesive bead at 20 and edge sealer at 25.

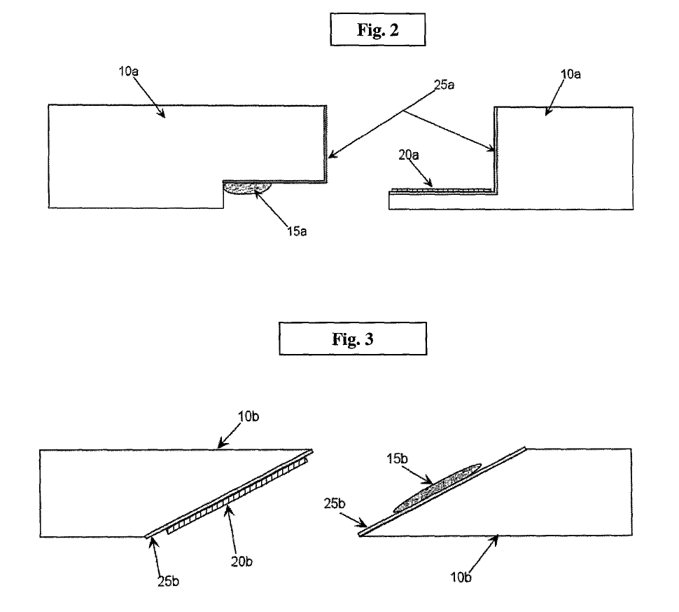

With reference to FIG. 2 which depicts in crossection two slats to be joining in a lap joint, adhesive resin at 15a is pre-applied to the recess on slat 10a, and initiator metal-containing layer affixed, e.g. adhesively, as a coating, ink, or foil, and the like affixed to the bonding edge of slat 10b. A sealer coating at 25a is shown on the edges, and is applied prior to affixing the activating or initiating metal containing layer 20a, and pre-applied adhesive 15a.

With reference to FIG. 3 which depicts a scarf joint configuration for joining members, adhesive resin is pre-applied to slat 10b on the right, which overlies a sealer layer at 25b. Initiator layer 20b is shown overlying the sealer layer on slat 10b on the left of the figure.

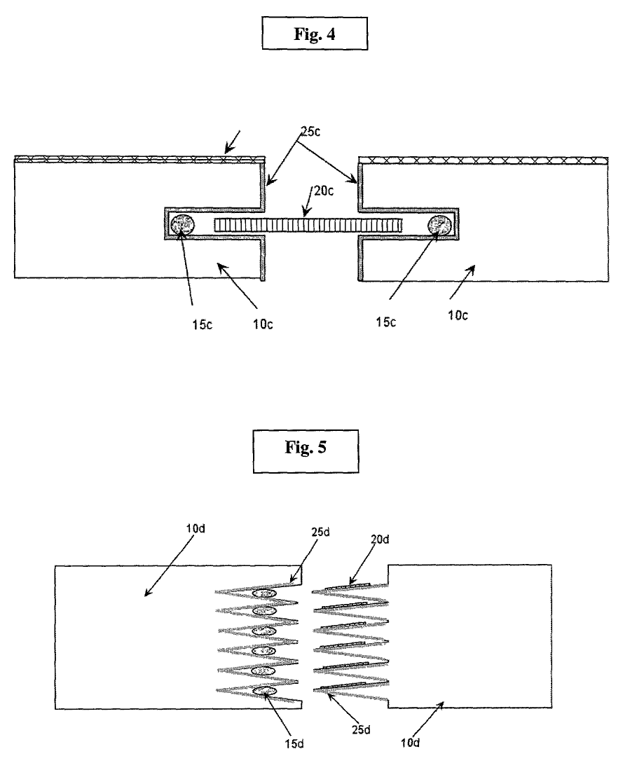

With reference to FIG. 4 which depicts two slats to be joined a spline joint, adhesive resin is applied in the inner region of grooves at 15c on both slats, and initiator is affixed to the spline 20c. An edge sealer is provided at 25c. An appearance coat is shown at 30

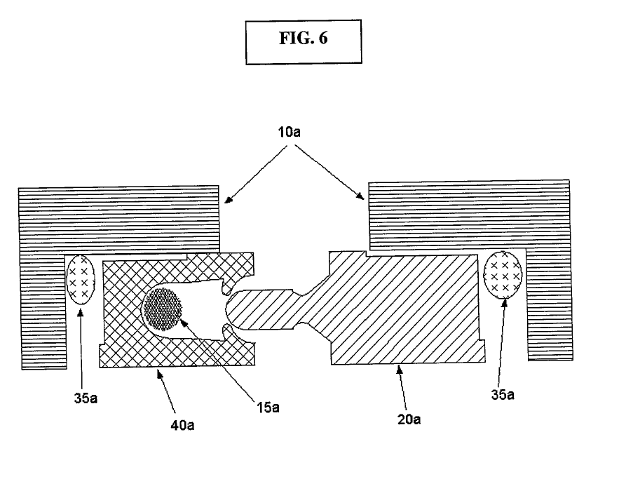

With reference to FIG. 5 two slats are aligned prior to joining in a finger joint with a plurality of adhesive resin beads applied at 15d, in the recess on the left-most slat 10d, and initiator layers 20d are affixed to the opposite, complementing slat, on the right. Underneath the bead, and initiator layers on each slat is applied an edge sealer at 25d.

FIG. 6 depicts in crossection two slats aligned prior to joining in a snap-fit engagement joint with adhesive resin applied between the slat and complementing male (20a) and female (40a) snap-fit inserts. The

Snap-fit inserts are affixed to each slat members 10a, by an adhesive 35a, or by laminating, sintering, or flame bonding of the snap-fit member, or any conventional bonding technique. Snap fit members are preferably formed by extruded cellular thermoplastics. Extrusion compounds containing cellular or blowing agents in vinyl (PVC), or styrenics (polystyrene) are commercially available widely. Only one embodiment of the snap-fit engagement is shown, although many conventional alternative snap-fit engagement profiles are contemplated for practice in the present invention.

Metal activated curable adhesive bead is placed in the internal cavity of the female snap-fit member at 15a. An initiator or activating metal is provided on the protruding portion of the male snap-fit member. When the two members are pressed together, in an interlocked position, the metal contacts the adhesive and curing takes place.

With respect to the adhesive aspect, the adhesive composition, in percent by weight; the amount of monomer(s) or monomer is typically and generally from 20-85%.

The amount of acid is typically in the range from about 0.05 to 20, preferably about 0.1 to 15, percent by weight.

An effective amount of sulfonyl compound ranges from about 1% to about 5%, preferably form 1.5% to 2% by weight.

An effective amount of transition metal initiator applied to the opposite or complimentary bonding edges in a layer accessible to and to be engaged with the opposing adhesive bead can be as little as 0.05 wt. Percent and as high as 15 wt. %, and preferably about 0.5 to 5, more preferably from 0.5 to 2 percent by weight per unit weight of curable adhesive applied in the opposing bead. The amount depends on the accessibility of the metal to the adhesive, the dis-aggregation of the metal after contact with the monomers of the adhesive, the surface area of the bond line edges, and other factors readily taken into account in predetermining an effective amount of transition activator metal.

The amount of optional oligomer can be in the range from zero to about 65 percent by weight.

An effective amount of thixotropic agent is generally from 3% to 7%, and the particular amount will be lower, e.g., 1 to 4% when optional filler is used, the weight percents being based on the total weight of the adhesive composition.

In order to provide sufficient shelf-aging, the olefinically unsaturated monomeric compound minimum critical molecular weight is at least 200, preferably at least 300, and contains at least one, and preferably more than one, e.g. two or three >C═C<groups, such as vinyl, vinylidene or allyl unsaturated groups, collectively referred to as “olefinically unsaturated” compounds. The olefinically unsaturated group is preferably a vinyl group, more preferably terminally located. Representative olefinically unsaturated monomers include, without limitation, olefins, acrylates, methacrylates, vinyl ethers, vinyl benzenes and acrylamides, and epoxy and urethane oligomers. Acrylate and methacrylate esters include isooctyl acrylate, isobornyl acrylate, stearyl acrylate, n-lauryl acrylate, cyclohexyl acrylate, 2-ethoxyethoxyethyl acrylate, 2-phenoxyethyl acrylate, isodecyl acrylate, 1,4-butanediol diacrylate, 1,3-butandiol diacrylate, 1,6-hexanediol diacrylate, diethylene glycol diacrylate, neopentylglycol diacrylate, triethylene glycol diacrylate, tripropylene glycol diacrylate, ethoxylated Bisphenol A diacrylate, trimethylol propane triacrylate, pentaerythritol triacrylate, ethoxylated trimethylol propane triacrylate, propoxylated trimethylol propane triacrylate. The preferred acrylates are stearyl acrylate, tripropylene glycol diacrylate, ethoxylated Bisphenol A diacrylate, ethoxylated trimethylol propane triacrylate, propoxylated trimethylol propane triacrylate, and trimethylol propane triacrylate.

Acrylate oligomers alone or in combination with monomers are also suitable. Acrylate oligomers known in the art include reaction products of acrylic acid with hydroxyl functional oligomers such as epoxies, polyesters and polyether polyols, and isocyanate functional monomers and oligomers. Aliphatic urethane oligomers are commercially available from Sartomer®, Inc.

An example of a conventional acrylourethane is disclosed in U.S. Pat. No. 5,091,211, incorporated herein by reference. These oligomers are made by reacting an acrylate monomer with an isocyanate terminal urethane prepolymer or oligomer. The prepolymer or oligomer is formed conventionally by reaction of an excess of polyisocyanate and a polyester, polyether, polyetherester or polycaprolactone polyol.

Preferred acrylate oligomers are reaction products of acrylic acid with hydroxyl functional oligomers such as epoxies, polyesters and polyether polyols, or isocyanate functional monomers and oligomers can be suitably employed.

More preferred are epoxy modified polyester acrylate having a final acid number of >5 mg KOH/g that is the reaction product of components that include: (a) a polyester polyol having a molecular weight less than 500; (b) an acrylate compound; and (c) an epoxy containing compound, wherein the polyester polyol and the acrylate compound are preformed to form a polyester acrylate, and the residual acrylate compound is reacted with the epoxy containing compound to form the epoxy modified polyester acrylate.

The formed polyester acrylate, with the preferred excess of the acrylate compound, is then combined with the epoxy containing compound to form the epoxy modified polyester acrylate. The final acid number in this aspect of the invention is from about 5 to 25, preferably 8 to 15 mg KOH/g.

The polyester polyols that can be used for forming epoxy modified polyester acrylates are defined as condensation polymers prepared by reacting a polycarboxylic acid (or anhydride thereof) or lactone with an excess of a multifunctional hydroxy compound.

Polycarboxylic acids which may be employed in forming the polyester polyols which are suitable for use in the present invention consist primarily of monomeric aliphatic, cycloaliphatic or aromatic acid carboxylic acids having at least two carboxyl groups or their anhydrides having from 2 to 14 carbon atoms per molecule, with dicarboxylic acids or their anhydrides being currently preferred. Among such useful acids are phthalic acid, isophthalic acid, terephthalic acid, tetrahydrophthalic acid, hexahydrophthalic acid, adipic acid, succinic acid, suberic acid, azelaic acid, sebacic acid, maleic acid, glutaric acid, chlorendic acid, tetrachlorophthalic acid, itaconic acid, trimellitic acid, tricarballylic acid, other known polycarboxylic acids of varying types and combinations thereof. It is currently preferred that the polyester polyol include phthalic acid or anhydride as at least part of the acid component.

The multi-functional hydroxy compounds utilized to prepare the polyester polyols of the invention can be any diol, triol or the like traditionally utilized to prepare polyester polyols. Examples of multi-functional hydroxy compounds include ethylene glycol, diethylene glycol, neopentyl glycol, 1,4-butane diol, 1,3-propane diol, 1,6-hexane diol, 2-methyl-1,3-propane diol, trimethylol propane, cyclohexanedimethanol, glycerol, erythritol, pentaerythritol, poly(ethylene oxide) diol, poly(ethylene oxide/propylene oxide) diol, polypropylene glycol, poly(tetramethylene oxide) diol and combinations thereof. A preferred multi-functional hydroxy compound includes diethylene glycol.

Illustrative of suitable carboxylic acid-based polyester polyols are poly(tetramethylene adipate)diol; poly(ethylene succinate)diol; poly(1,3-butylene sebacate)diol; poly(hexylene phthalate)diol; 1,3-butylene glycol/glycerin/adipic acid/isophthalic acid) diols and triols; 1,6-hexane diol phthalate polyester diol; 1,6-hexane diol adipate diol; 1,6-hexane diol ethylene glycol adipate diol; diethylene glycol phthalate diol and the like. A particularly preferred polyester polyol is based on the reaction product of diethylene glycol and phthalic anhydride sold under the trade name Stepan® 3152.

The polyester polyols of the invention may also be prepared by reacting a suitable lactone with the multi-functional hydroxy compound defined above according to methods known in the art. Lactones useful for this purpose typically have the following formula:

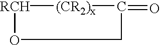

wherein R is hydrogen or an alkyl group having from 1 to 12 carbon atoms, x is from 4 to 7 and at least (x−2) R's are hydrogen. Preferred lactones are the epsilon-caprolactones wherein x is 4 and at least 6 of the R's are hydrogen with the remainder, if any, being alkyl groups. Preferably, none of the substituents contain more than 12 carbon atoms and the total number of carbon atoms in these substituents on the lactone ring does not exceed 12. Unsubstituted epsilon-caprolactone, i.e., where all the R's are hydrogen, is a derivative of 6-hydroxyhexanoic acid. Both the unsubstituted and substituted epsilon-caprolactones are available by reacting the corresponding cyclohexanone with an oxidizing agent such as peracetic acid. Substituted epsilon-caprolactones found to be most suitable are the various epsilon-monoalkylcaprolactones wherein the alkyl groups contain from 1 to 12 carbon atoms, e.g., epsilon-methylcaprolactone, epsilon-ethylcaprolactone, epsilon-propylcaprolactone and epsilon-dodecylcaprolactone. Useful also are the epsilon-dialkylcaprolactones in which the two alkyl groups are substituted on the same or different carbon atoms, but not both on the omega carbon atoms. Also useful are the epsilon-trialkylcaprolactones wherein 2 or 3 carbon atoms in the lactone ring are substituted provided, though, that the omega carbon atom is not disubstituted. The most preferred lactone starting reactant is the epsilon-caprolactone wherein x in the formula is 4 and all the R's are hydrogen.

Examples of commercially available lactone-based polyester polyols include those based on diethylene glycol, trimethylol propane, and neopentyl glycol sold by Union Carbide Corporation under the trade names TONE 0200, 0300, and 2200 series, respectively.

The molecular weight of the polyester polyols ranges from about 250 to <500, preferably from about 250 to 400, more preferably about 350. The acrylate compound (alternatively called “acrylate forming compound”) useful for reacting with the polyester polyols to form the polyester acrylate can be any acrylate compound corresponding to the formula:

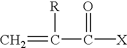

wherein R can be H or CH₃; X can be OH, OY, Cl, Br or F and Y can be an alkyl, aryl or cycloalkyl hydrocarbon radical having from 1 to 10, preferably from 1 to 5, carbon atoms. R is preferably H and X is preferably OH. The acrylate compound can also be the anhydrides of compounds corresponding to the above structure where X═OH.

Examples of acrylate compounds suitable for reacting with the polyester polyols to form the polyester acrylate include acrylic acid, methacrylic acid, methyl acrylate, ethyl acrylate, butyl acrylate, hexyl acrylate, cyclohexyl acrylate, phenoxyethyl acrylate, methyl methacrylate, acryloyl chloride, acrylic anhydride, and methacrylic anhydride, with acrylic acid being preferred.

The polyester acrylate can be prepared by combining the polyester polyol and the acrylate compound (preferably in an excess of acrylate) preferably in a hydroxy group/acrylate equivalent ratio ranging from about (0.1-1.00):1, more preferably ranging from about (0.3-1.0):1. When X═OH in the structure given above for the acrylate compound, the acrylate compound and the polyester polyol may be reacted in a direct esterification reaction. The esterification reaction typically utilizes an acid catalyst. Typical acid catalysts useful for this purpose include sulfuric acid, p-toluene sulfonic acid, methane sulfonic acid, cation ion exchange resins and mixtures thereof, with methane sulfonic acid and a mixture of methane sulfonic acid and a cation exchange resin being presently preferred. An acid catalyst is typically utilized in an amount ranging from about 0.10 to 5.0, preferably from about 0.25 to 1.0, percent by weight of the total ingredients utilized to prepare the polyester acrylate. The esterification reaction may also utilize a polymerization inhibitor such as methyletherhydroquinone, toluhydroquinone or phenothiazine, and the reaction may be carried out in the presence of a hydrocarbon solvent such as toluene, which forms an azeotrope with water. The reaction is heated at reflux temperature and the water formed is removed, driving the equilibrium to the left.

When X═OY in the structure given above, the acrylate compound and the polyester polyol may be reacted in a transesterification reaction. Transesterification catalysts such as tin or titanate salts are typically utilized in this process. When X═Cl, Br, or F, the acrylate compound and polyester polyol may be reacted in the presence of a base catalyst.

The polyester acrylate may be utilized in an amount ranging from about 10 to 95, preferably from about 40 to 90, more preferably 80 to 90 and most preferably about 85 percent by weight of the essential ingredients utilized to prepare the epoxy modified polyester acrylate. The essential ingredients utilized to prepare the epoxy-modified polyester acrylate herein refers to the polyester acrylate, and the epoxy containing compound.

The epoxy containing compounds that can be used to form an epoxy modified polyester acrylate can include any compound containing a 1, 2-epoxide group. Examples of suitable epoxides are mono-, di- or polyepoxide compounds are epoxidized olefins, glycidyl esters of saturated or unsaturated carboxylic acids or glycidyl ethers of aliphatic or aromatic polyols. A particularly preferred epoxide is a glycidyl ether of bisphenol A sold under the name Araldite® GY 6010 epoxy. Other epoxy containing compounds such as those described in EP 126341, which is incorporated herein by reference, can also be used. A balance of properties and reactivity can be achieved by using a combination of two or more different epoxy compounds. The different epoxies can be used as a blend or added sequentially. A particularly preferred procedure is to first use a glycidyl ether of Bisphenol-A sold as Araldite® GY 6010 and then a glycidyl ester of a tertiary branched monocarboxylic acid sold as Cardura® E-10.

The epoxy modified polyester acrylates useful in the present invention can be prepared by any of several known reaction routes. An example of one preferred reaction route is to first react the polycarboxylic acid with the acrylate compound to form the polyester acrylate containing residual acrylate compound. The acrylate compound can be provided in a stoichiometric amount, a less than stoichiometric amount or in excess. As described above, an excess is generally preferred. The residual acrylate compound is then reacted with the epoxy containing compound, with the excess of the acrylate compound, if present. If excess acrylate compound is present, it can be either present in excess from the first reaction step, or can separately be added during the reaction of the polyester acrylate with the epoxy containing compound.

Suitable methacrylates are exemplified by cyclohexyl methacrylate, n-hexyl methacrylate, 2-ethoxyethyl methacrylate, isodecyl methacrylate, lauryl methacrylate, stearyl methacrylate, 2-phenoxyethyl methacrylate, isobornyl methacrylate, triethylene glycol dimethacrylate, tetraethylene glycol dimethacrylate, 1,3-butanediol dimethacrylate, 1,4-butanediol dimethacrylate, 1,6-hexanedioldimethacrylate, neopentyl glycol dimethacrylate, ethoxylated Bisphenol A dimethacrylate, trimethylol propane trimethacrylate. The preferred methacrylates are 1,6-hexanediol dimethacrylate, stearyl methacrylate, ethoxylated Bisphenol A dimethacrylate and trimethylol propane trimethacrylate. Other methacrylate monomers and oligomers can be reaction products of methacrylic acid with hydroxyl functional monomers and oligomers such as epoxies, polyesters and polyether polyols, and isocyanate functional monomers and oligomers. Typical allyl functional monomers and oligomers are diallyl phthalate, diallyl maleate and allyl methacrylate. The preferred allyl functional compound is diallyl phthalate.

Examples of monofunctional compounds which can be given include 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, isobutoxymethyl (meth) acrylamide, N,N-dimethyl (meth)acrylamide, t-octyl (meth)acrylamide, dimethylaminoethyl (meth) acrylate, diethylaminoethyl (meth)acrylate, 7-amino-3,7-dimethyloctyl (meth)acrylate, N,N-diethyl (meth)acrylamide, N,N-dimethylaminopropyl (meth)acrylamide, hydroxybutyl vinyl ether, lauryl vinyl ether, cetyl vinyl ether, 2-ethylhexyl vinyl ether, and compounds represented by the following formula (3).

CH₂═C(R²)—COO(R³O)ₙ—R⁴ (3)

wherein R² indicates a hydrogen atom or a methyl group; R³ is an alkylene group with 2 to 6, preferably 2 to 4, carbon atoms; R⁴ is a hydrogen atom or an alkyl group with 1 to 12, preferably 1 to 9, carbon atoms, and m is an integer from 0 to 12, preferably from 1 to 8.

Polyfunctional olefinically unsaturated compounds include, for example, pentaerythritol tri(meth)acrylate, ethylene glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, trimethylolpropanetrioxydiethyl (meth)acrylate, tris(2-hydroxyethyl)isocyanurate tri(meth)acrylate, tris(2-hydroxyethyl)isocyanurate di(meth)acrylate, tricyclodecanedimethanol di(meth)acrylate, epoxy (meth)acrylates which are (meth)acrylate addition compounds of diglycidyl ethers of bisphenol-A, triethylene glycol divinyl ether, and the like. Also, examples of commercial products which can be used are UPIMA-UV SA1002, SA2007 (manufactured by Mitsubishi Petrochemicals), BISCOAT 700 (manufactured by Osaka Organic Chemicals), EAYAAAD R604, DPCA-20, DPCA-30, DPCA-60, DPCA-120, Mx-620, D-310, D-330 (manufactured by Nippon Kayaku), ARONIX M210, M215, M315, M325, (manufactured by Toagosei Chemical Industry), and the like. Particularly desirable among these examples are tricyclodecanedimethanol di(meth)acrylate (YUPINA-UV SA002) and BISCOAT 700.

Examples of commercial products which can be used are ARONIX MI11, MI13, HI 14, M117, (manufactured by Toagosei Chemical Industry), TC110S, R629, R644 (manufactured by Nippon Kayaku) and BISCOT 3700 (manufactured by Osaka Organic Chemicals) and the like.

The acid can be any organic or inorganic acid having at least one acid group, and includes organic partial esters of such acids. The acidic compounds are in the nature of Brönsted acids, that is, compounds which can donate a proton. Suitable acidic compounds preferably have a pKa less than about 6, most preferably in the range from about 1.0 to 5. The acidic compounds should also be reasonably soluble in the adhesive compositions of the invention to facilitate homogeneous distribution of the acid throughout the composition. Organic acids, as well as organic partial esters of such acids. The inorganic acids, and the organic partial esters of such acids, are preferred. Acidic compounds which contain both at least one acid group and at least one olefinically-unsaturated moiety may also be employed.

Representative acidic compounds which are suitable for use in the practice of the invention include phosphoric acid esters, e.g., 2-hydroxyethyl methacrylate partial ester of phosphoric acid, 2-hydroxyethyl acrylate partial ester of phosphoric acid, phosphoric acid, benzenephosphonic acid, phosphorous acid, sulfuric acid, sulfurous acid, 2-ethylhexonic acid, formic acid, acetic acid, butyric acid, hexanoic acid, napthenic acid, lauric acid, linoleic acid, valeric acid, toluene sulfonic acid, nitrotoluene sulfonic acid, dichloroacetic acid, trichloroacetic acid, phenylacetic acid, sulfosalicylic acid, naphthalene disulfonic acid, acetoacetic acid, acrylic acid, methacrylic acid, aminobenzosulfonic acid, maleic acid, malonic acid, phthalic acid, suberic acid, succinic acid, and vinyl acetic acid with 2-hydroxyethyl methacrylate partial ester of phosphoric acid, and 2-hydroxyethyl acrylate partial ester of phosphoric acid being preferred.

Acidic compounds having a pKₐ of about 1 are less preferred on account of corrosivity. Too large an amount of acidic compound can lead to less than optimum adhesion values. An amount of from 0.05 to 20 weight percent on weight of adhesive is preferred.

Suitable sulfonyl-containing compounds can be selected from the group consisting of sulfonyl-sulfur, sulfonyl phosphorus and sulfonyl-silicon compounds. The sulfonyl-containing compounds generally comprise at least one compound containing at least one sulfonyl group having the structure:

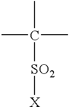

wherein X is hereinafter defined with respect to each type of sulfonyl-containing compound and can be X is SR′, S(O)R′, or SO₂R′, with R′ being any organic or inorganic moiety. R′ is preferably hydrogen; lower alkyl such as methyl, ethyl, or propyl; phenyl; phenylmethyl; or an ion such as sodium, potassium, or zinc. R′ is most preferably methyl or phenyl. Specific examples of X for the present sulfonyl-sulfur compounds include —SH, —S⁻Na⁺, —SCH₃, —SC₂H₅, —SC₆H₅, —SC₆H₄CH₃; —S(O)H, —S(O)⁻Na⁺, —S(O)CH₃, —S(O)C₂ H₅, —S(O)C₆ H₅, —S(O)C₆ H₄ CH₃; —SO₂ H, —SO₂⁻Na⁺, —SO₂CH₃, —SO₂C₂H.₅, —SO₂C₆H₅, and —SO₂C₆H₄CH₃.

Specific examples of sulfonyl-sulfur compounds include S-phenylbenzenethiosulfonate (diphenyldisulfide-S,S-dioxide);α-diphenyldisulfone (diphenyldisulfide-S,S,S′,S′-tetroxide); α-dimethyl-disulfone (dimethyldisulfide-S,S,S′,S′-tetroxide), S,S′-ethylene-p-toluene-thiosulfonate, 1,2-dithiane-1,1,2,2-tetroxide, p-tolylsulfinyl-p-toluenesulfone (di-p-tolyldisulfide-S,S,S′-trioxide), 1,2-dithiolane-1,1,2,2-tetroxide, 1,2-dithiane -1,1,2-trioxide, methanethiosulfonic acid, sodium methanethiosulfonate, benzenethiosulfonic acid anhydride, with S-phenylbenzenethiosulfonate and a-diphenyldisulfone being preferred sulfonyl-sulfur compounds.

The sulfonyl phosphorus compounds represented by the above structure include where X is P(R″)₂. or P(O)(R″)₂ with R″ being essentially any organic or inorganic moiety. Preferably, R″ is independently hydrogen; lower alkyl such as methyl, ethyl, or propyl; lower alkoxy such as methoxy, ethoxy or propoxy; or phenyl. Preferably, R″ is ethoxy. Specific examples of X for the sulfonyl phosphorus compounds include —P(CH₃)₂, —P(H)(CH₃), —P(C₂ H₅)₂, —P(OCH₃)₂, —P(OC₂H₅)₂, —P(CH₃)(OC₂H₅), —P(C₆H₅)OCH₃, —P(O)(CH₃)₂, —P(O)(H)(CH₃), —P(O)(H)₂, —P(O)(OH)₂, —P(O)(C₂H₅)₂, —P(O)(OCH₃)₂, —P(O)(OC₂H₅)₂, —P(O)(CH₃)(OC₂H₅), and —P(O)(C₆H₅)OCH₃.

The exemplary sulfonyl phosphorus compounds include phenylsulfonyl diethoxy phosphine oxide, methylsulfonyl dimethylphosphine, methylsulfonyl diethylphosphine oxide, with phenylsulfonyl diethoxy phosphine oxide being preferred.

The sulfonyl-silicon compounds used in the adhesive system of the invention can be represented by the above structure wherein X is Si(R′″)₃ with R′″ being essentially any organic or inorganic moiety. Preferably, R′″ is independently lower alkyl such as methyl, ethyl or propyl; hydroxy; lower alkoxy such as methoxy, ethoxy or propoxy; phenyl; or an oxy salt such as oxy sodium or oxy potassium. Most preferably, R′″ is methyl. Specific examples of X for the sulfonyl-silicon compounds include —Si(CH₃)₃, —Si(C₂H₅)₃, —Si(C₆H₅)₃, —Si(OH)₃, —Si(OC₂H₅)₃, —Si(O⁻Na⁺)₃, —Si(CH₃)(OCH₃)₂, —Si(OH)₂(OC₆H₅), and —Si(OC₂H₅)(OCH₃)₂. Typical sulfonyl-silicon compounds include methanesulfonyl trimethylsilane, benzenesulfonyltriethoxysilane, methanesulfonyltrihydroxysilane and ethanesulfonylethoxydimethoxysilane, with methanesulfonyl trimethylsilane being preferred.

Although R′, R″, and R′R″ are defined above with respect to preferences for the respective sulfonyl-sulfur, phosphorus and -silicon compounds, R′, R″, and R′″ can, in general, be any substituted or unsubstituted alkyl group containing typically from 1 to 24 carbon atoms; or any substituted or unsubstituted aryl group containing typically from 6 to 30 carbon atoms. Organic R′, R″, and R′R″ groups can also be polymeric materials, such as polyolefins or polyurethanes. Inorganic R′, R″, and R′R″ groups include H, OH, SH, NH₂, SiOH, Cl, and metal ions such as Na⁺, Mg²⁺, Ni²⁺, and Al³⁺.

The amount of sulfonyl-containing compound is generally suitable in a range of from 0.05 to about 5% by weight on weight of adhesive in the bead applied to the one set of members to be joined. The sulfonyl compounds are available commercially and can be made by conventionally known methods.

The metal initiators include salts and organic derivatives or complexes of copper, zinc, cobalt, vanadium, iron and manganese. Inorganic compounds containing the transition metals as the metal salts exemplified by the bromides, chlorides, phosphates, sulfates, sulfides and oxides of the transition metals. Likewise, organic compounds containing the transition metals can be used, such as transition metal salts of organic mono- and poly-carboxylic acids; and mono- and poly-hydroxy compounds, such as cupric acetate, cupric maleate, cupric hexoate, iron naphthenate, cobaltous and cobaltic naphthenate and the like. Particularly preferred organic derivatives are sulfamide and sulfonamide compounds which contain the transition metal. This partial listing of suitable organic and inorganic transition metal salts will lead to suggestive other useful salts as will be readily obvious to those skilled in the art. The transition metal compounds will be employed in the adhesive compositions of this invention in a range from about 0.05 to 5, preferably about 0.2 to 2.5, percent by weight, based on the total weight of the adhesive composition.

The transition metal-containing organic compounds are typically soluble when contacted with the adhesive compositions, are preferred activating metal compounds. It is preferred that the activator transition metal compound, be it organic or inorganic, have some degree of solubility, either in the adhesive composition itself or in an inert solvent which is preferably compatible with the adhesive compositions. In the use of a transition metal having limited solubility, these can advantageously be dissolved in an inert solvent or carrier material as part of the metal activator layer formed on the opposite complimentary edges of the articles to be joined.

The adhesive system should exhibit a degree of self-support, and resist flow after applied to the part. This is advantageously obtained with the use of a thixotrope. Suitable thixotropes are conventionally used in adhesive compounds. Thixotropic properties can be achieved from a myriad of known additives in the art and include alumina, limestone, talc, zinc oxides, sulfur oxides, calcium carbonate, perlite, slate flour, salt (NaCl), cyclodextrin and the like. Thixotropes provide an essential antisagging property in the present adhesive system. Exemplary thixotropes include castor waxes, treated clays also referred to as Fuller's earth clays including sepiolite, palygorskite and attapulgite, and the preferred silicas like fumed silica. Useful sources of the thixotrope include those available under the AEROSIL® mark from Degussa, Cab-O-SIL® from Cabot, CASTORWAX® from Caschern, BENTONE®, THIXATROL® and THIXCIN® from Rheox, and DISLON® from King. Attapulgite, hydrated magnesium silicate clay processed by Engelhard Co., Floridin Co. and others are effective thixotropes. The following U.S. patents teach various conventional thixotropic additives for use in the present adhesive system used herein: U.S. Pat. Nos. 5,476,889, 5,247,000, 5,204,386, 5,152,918, 5,001,193, 6,133,398, 5,852,103, 4,940,852 and 5,385,990.

Optional components includable in the adhesive are conventional inhibitors, antioxidants, fillers and stabilizers.

The sealers which are suitable are conventional waxes, paraffins, in particular, acrylic, vinyl, SBR, PVDC latex paints and coatings, urethanes, and the like. They can be roller coated, such as with a foam roller, or spray applied, or other conventional edge coating method. A preferred type of sealer is an acrylic curable coating containing a photoinitiator. Suitable conventional UV curable coatings are disclosed in U.S. Pat. No. 6,146,288 incorporated by reference. A UV cured coating containing an aziridine crosslinker is more preferred.

The geometries available for the panel or slat joint design are too numerous to mention all which are suitable. Such designs include, but are not limited to, tongue and groove, scarf, lap, strap, finger, grooves an spline, and snap-fit joints. In joints of the tongue and groove type and most snap fit geometries, the adhesive is preferentially applied in a recess, or corner, such as within a groove or female, or any recessed portion to advantageously avoid contact during handling. The cure activator would correspondingly be placed on the tongue or male snap fit portion. The spline design would contain adhesive in both grooves and the spline would carry the cure activator. Designs of lap and scarf type would utilize adhesive on one joint face and the cure activator on the other joint face. Grooves can be on all sides of a member, and tongues can be on all sides of a complementing member. Elongated slats, such as individual flooring slats typically have on each member a tongue side and a groove side.

As one example, FIG. 1 shows the unassembled mating edges of two board materials using the tongue and grove approach. FIG. 2 shows the same joint in its assembled state.

With reference to FIG. 6, where like references depict similar structures, there are the members to be joined such as a plank, slat or board at 10a, and in one embodiment where the bonding is shown with respect to joining adjacent sides, a pre-applied adhesive is applied at 15a, a male snap fit tongue 20a coated with activator metal in the protruding engagement area, A moisture curing conventional two-component adhesive is applied, and shown prior to bonding of snap fit parts at 35a, and a female receiver portion of snap fit at 40a.

Application methods suitable to apply the pre-applied adhesive are:

1. A self supporting bead is applied to upper and or lower groove surfaces using pneumatic, or hydraulic dispensing equipment common to the adhesive industry—the bead is spread along the groove surface when tongue is inserted.

2. A layer of adhesive is sprayed on using conventional spray equipment common to the coatings and adhesive industry.

3. A bead of adhesive is applied to the back of a groove and spread onto upper and lower groove surfaces using a air knife or similar device.

4. A layer of adhesive is applied using sponge or drip roller designed for the groove profile.

### BONDING EXAMPLES

A tongue and groove type joint of medium density fiberboard (MDF) was joined. Firstly the surface area of the tongue and groove was coated (˜0.001″ thick) with a conventional UV curable acrylic coating. The sealer coating was cured using an Aetek UV curing unit which applied approximately 1200 mJ/cm² energy. This coating was applied to prevent compounds (probably lignin and formaldehyde) in the MDF from inhibiting adhesive cure. This phenomenon was previously observed when attempting to join MDF in lap shear geometry. An adhesive formulation was then applied in the groove. The tongue was first coated with a Lord UV curable coating with zinc powder dispersed into it. This coating was cured to the tongue using the same UV cure unit and energies as described above and lightly abraded to expose fresh zinc on the surface. The prepared tongue and groove samples were then joined. Joint strengths were tested after 24 hours and averaged 94 lbs./in.

The following formulas were used.

| Resin side: | | | |
|---|---|---|---|
| Ingredient | Wt. (g) | Density | Wt. % |
| Monomer* | 50.00 | 1.10 | 85.62 |
| Thixotrope | 3.00 | 2.40 | 5.14 |
| Phosphate ester** | 3.60 | 1.00 | 6.16 |
| Copper (II) acetate | 0.80 | 1.80 | 1.37 |
| 4-methoxybenzenesulfonyl chloride | 1.00 | 0.90 | 1.71 |
| Total | 58.40 | | |

*ethoxylated trimethylol propane triacrylate

| Example 2 | | | |
|---|---|---|---|
| Ingredient | Wt. (g) | Density | Wt. % |
| Monomer* | 16.00 | 1.10 | 18.41 |
| Talc | 24.00 | 2.40 | 27.62 |
| Thixotrope | 1.50 | 2.40 | 1.73 |
| Phosphate ester | 3.60 | 1.00 | 4.14 |
| Copper (II) acetate | 0.80 | 1.80 | 0.92 |
| 4-methoxybenzenesulfonyl chloride | 1.00 | 0.90 | 1.15 |
| Conventional acrylic oligomer | 40.00 | 1.00 | 46.03 |

*hexane diol diacrylate

| Example 3 | | | |
|---|---|---|---|
| Ingredient | Wt. (g) | Density | Wt. % |
| HDODA | 16.00 | 1.10 | 18.41 |
| Nicron 353 | 24.00 | 2.40 | 27.62 |
| Aerosil R-202 | 1.50 | 2.40 | 1.73 |
| Hydroxyethyl methacrylate | 3.60 | 1.00 | 4.14 |
| Phosphate | | | |
| Copper (II) acetate | 0.80 | 1.80 | 0.92 |
| 4-methoxybenzenesulfonyl | 1.00 | 0.90 | 1.15 |
| chloride | | | |
| Acrylic oligomer | 40.00 | 1.00 | 46.03 |
| Total | 86.90 | | |

The adhesives in each example were applied to a wood slat shaped to provide a groove side and a tongue side. A bead of adhesive was applied in the groove. Zinc metal foil strips were adhered using a conventional pressure sensitive adhesive to the upper and lower surfaces on the tongue side of another identical wood slat. The groove on the adhesive treated slat was joined to the tongue of the other slat, and allowed to cure under ambient conditions. The following bonding results from examples 1-3 were obtained in a tensile tester.

| Groove | Tongue | |
|---|---|---|
| Depth | Length | Strength |
| (mm) | (mm) | (pli) |
| 5.1 | 4.1 | 66 |
| 5.1 | 4.1 | 100 |
| 7.5 | 6.5 | 122 |
| 10.5 | 9.5 | 104 |
| 10.5 | 9.5 | 103 |

We claim:

1. Rigid panels adapted to be joined in a plurality of individual panels, comprising upper and lower surfaces, at least first and second lateral joining surfaces, said surfaces adapted for joining to complimenting panels, wherein applied to at least said first lateral joining surface is a single-package, ambient temperature-curable adhesive composition comprising:
(A) at least one olefinically unsaturated monomer having a molecular weight of greater than or equal to 300;
(B) an acidic compound having at least one organic or inorganic acid group;
(C) at least one sulfonyl-containing compound,
(D) at least one organic or inorganic compound containing at least one reducible transition metal,
and wherein affixed to at least a said second lateral joining surface on the same of a different individual panel is at least one reducible, elemental transition metal.

2. The panels of claim 1 composed of natural or synthetic wood.

3. The panels of claim 1 composed of a metal, and wherein said first and said second lateral joining surface consists essentially of non-initiating metal(s) for said curable adhesive.

4. The panels of claim 1 where said affixed elemental transition metal is a zinc metal tape.

5. The panels of claim 1 composed of a metal, and wherein said first and said second lateral joining surface consists essentially of non-initiating metal(s).

6. The panels of claim 2 further comprising an upper appearance layer affixed to said upper surface.

7. The panels of claim 1 wherein said olefinically unsaturated monomer is selected from the group consisting of cyclohexyl methacrylate, n-hexyl methacrylate, 2-ethoxyethyl methacrylate, isodecyl methacrylate, lauryl methacrylate, stearyl methacrylate, 2-phenoxyethyl methacrylate, isobornyl methacrylate, triethylene glycol dimethacrylate, tetraethylene glycol dimethacrylate, 1,3-butanediol dimethacrylate, 1,4-butanediol dimethacrylate, 1,6-hexanedioldimethacrylate, neopentyl glycol dimethacrylate, ethoxylated Bisphenol A dimethacrylate, trimethylol propane trimethacrylate, isooctyl acrylate, isobornyl acrylate, stearyl acrylate, n-lauryl acrylate, cyclohexyl acrylate, 2-ethoxyethoxyethyl acrylate, 2-phenoxyethyl acrylate, isodecyl acrylate, 1,4-butanediol diacrylate, 1,3-butandiol diacrylate, 1,6-hexanediol diacrylate, diethylene glycol diacrylate, neopentylglycol diacrylate, triethylene glycol diacrylate, tripropylene glycol diacrylate, ethoxylated Bisphenol A diacrylate, trimethylol propane triacrylate, pentaerythritol triacrylate, ethoxylated trimethylol propane triacrylate, propoxylated trimethylol propane triacrylate.

8. The panels of claim 2 wherein wherein the olefinically unsaturated monomer is selected form the group consisting of olefins, acrylates, methacrylates, vinyl ethers, vinyl benzenes and acrylamides, and epoxy and urethane oligomers

9. The panels of claim 1 wherein the acidic compound is selected from the group consisting of 2-hydroxyethyl methacrylate partial ester of phosphoric acid, and 2-hydroxyethyl acrylate partial ester of phosphoric acid.

10. The panels according to claim 4 wherein the acidic compound is 2 hydroxyethyl methacrylate partial ester of phosphoric acid.

11. The panels according to claim 1 wherein the sulfonyl-containing compound is a sulfonyl-sulfur compound and is selected from the group consisting of S-phenylbenzenethiosulfonate, α-diphenyldisulfone, α-dimethyldisulfone, S,S″-ethylene-p-toluenethiosulfonate, and 1,2-dithiane-1,1,2,2-tetroxide.

12. The panels according to claim 11 wherein the sulfonyl-containing compound is S-phenylbenzenethiosulfonate or α-diphenyldisulfone.

13. The panels according to claim 1 wherein the sulfonyl-containing compound is a sulfonyl-phosphorus or sulfonyl-silicon compound and is selected from the group consisting of phenylsulfonyl diethyoxy phosphine oxide, methylsulfonyl dimethylphosphine, methylsulfonyl diethylphosphine oxide, methanesulfonyl trimethylsilane, benzene-sulfonyltriethoxylsilane, methanesulfonyltrihydroxysilane, and ethane-sulfonylethoxydimethoxysilane.

14. The panels according to claim 8 wherein the sulfonyl-containing compound is phenylsulfonyl diethyoxy phosphine oxide or methanesulfonyl trimethylsilane.

15. The panels according to claim 1 wherein the organic or inorganic compound containing at least one reducible transition metal is an organic compound selected from the group consisting of cupric saccharinate, cupric acetate, cupric maleate, cupric hexoate, iron naphthenate, cobaltous naphthenate, and cobaltic naphthenate.

16. A plurality of wood flooring panels adapted to be joined together in a plurality of individual panels bonded together, each panel comprising upper and lower surfaces, at least first and second lateral joining surfaces, said surfaces adapted for joining to complimenting panels, wherein applied to said at least first lateral joining surface is a single-package, ambient temperature-curable adhesive composition comprising:
(A) at least one olefinically unsaturated monomer;
(B) an acidic compound having at least one organic or inorganic acid group;
(C) at least one sulfonyl compound,
(D) at least one organic or inorganic compound containing at least one reducible transition metal,
and wherein affixed to at least one said second lateral joining surface on the same or a complimenting panel is at least one reducible, elemental transition metal.

17. The flooring panels of claim 16 composed of natural or synthetic wood.

18. The flooring panels of claim 2 further comprising a laminated or coated appearance layer on at least one of said upper and lower surfaces.
